(19) United States
(12) Patent Application Publication
(10) Pub. No.: US 2007/0230754 A1
(43) Pub. Date: Oct. 4, 2007

(54) LEVEL 3 FEATURES FOR FINGERPRINT MATCHING

(76) Inventors: Anil K. Jain, Okemos, MI (US); Yi Chen, Lansing, MI (US); Meltem Demirkus, East Lansing, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/692,524

(22) Filed: Mar. 28, 2007

Related U.S. Application Data
(60) Provisional application No. 60/743,986, filed on Mar. 30, 2006.

(51) Int. Cl. G06K 9/00

(52) U.S. Cl. 382/125

(57) ABSTRACT

Fingerprint recognition and matching systems and methods are described that utilize features at all three fingerprint friction ridge detail levels, i.e., Level 1, Level 2 and Level 3, extracted from 1000 ppi fingerprint scans. Level 3 features, including but not limited to pore and ridge contour characteristics, were automatically extracted using various filters (e.g., Gabor filters, edge detector filters, and/or the like) and transforms (e.g., wavelet transforms) and were locally matched using various algorithms (e.g., the iterative closest point (ICP) algorithm). Because Level 3 features carry significant discriminatory and complementary information, there was a relative reduction of 20% in the equal error rate (EER) of the matching system when Level 3 features were employed in combination with Level 1 and Level 2 features, which were also automatically extracted. This significant performance gain was consistently observed across various quality fingerprint images.

### CROSS-REFERENCE TO RELATED APPLICATION

The instant application claims priority to U.S. Provisional Patent Application Ser. No. 60/743,986, filed Mar. 30, 2006, the entire specification of which is expressly incorporated herein by reference.

### FIELD OF THE INVENTION

The present invention relates generally to fingerprint matching systems, and more particularly to new and improved fingerprint recognition and matching systems that are operable to employ and analyze Level 3 features, including but not limited to pore and ridge characteristics, as well as Level 1 and Level 2 features.

### BACKGROUND OF THE INVENTION

Fingerprint identification is based on two properties, namely, uniqueness and permanence. It has been suggested that no two individuals (including identical twins) have the exact same fingerprints. It has also been claimed that the fingerprint of an individual does not change throughout the lifetime, with the exception of a significant injury to the finger that creates a permanent scar.

Characteristic fingerprint features are generally categorized into three levels. Level 1 features or patterns, are generally the macro details of the fingerprint such as ridge flow and pattern type. Level 2 features, or points, generally refer to the Galton characteristics or minutiae, such as ridge bifurcations and endings. Level 3 features, or shape, generally include all dimensional attributes of the ridge such as ridge path deviation, width, shape, pores, edge contour, incipient ridges, breaks, creases, scars, and other permanent details (e.g., see FIG. 1).

Statistical analysis has shown that Level 1 features, though not unique, are useful for fingerprint classification (e.g., into whorl, left loop, right loop, and arch classes), while Level 2 features have sufficient discriminating power to establish the individuality of fingerprints. Similarly, Level 3 features are also claimed to be permanent, immutable and unique according to the forensic experts, and if properly utilized, can provide discriminatory information for human identification.

In latent (partial) print examination, both Level 2 and Level 3 features play important roles in providing quantitative, as well as qualitative, information for identification. Unfortunately, commercial automated fingerprint identification systems (“AFIS”) barely utilize Level 3 features. This is because in order to extract fine and detailed Level 3 features, high resolution (e.g., ≧1000 pixels per inch (ppi)) images are needed. Because current AFIS systems are based only on 500 ppi images, the matchers used in these systems have been developed primarily based on Level 1 and Level 2 features.

With the advent of high resolution fingerprint sensors and growing demand and requirements for accurate and robust latent print examination, there is a need to quantify the discriminating power of Level 3 features. In the 2005 ANSI/NIST Fingerprint Standard Update Workshop, the Scientific Working Group on Friction Ridge Analysis, Study and Technology (SWGFAST) proposed a minimum scanning resolution of 1000 ppi for latent, tenprint, and palm print images and the inclusion of Level 3 fingerprint features in the FBI standard. This proposal was strongly endorsed by the forensic community and initiated the establishment of an ANIS/NIST committee, named CDEFFS, to define an extended fingerprint feature set. This is supposedly the first attempt to quantify some of the Level 3 features that are being defined in the “extended feature set” for fingerprint matching.

The history of using fingerprints as a scientific method for identification traces back to the 1880s, when Faulds suggested that latent fingerprints obtained at crime scenes could provide knowledge about the identity of offenders. In 1892, Galton published the well-known book entitled Fingerprints, in which he discussed the basis of contemporary fingerprint science, including persistence, uniqueness and classification of fingerprints. Galton introduced Level 2 features by defining minutia points as either ridge endings or ridge bifurcations on a local ridge. He also developed a probabilistic model using minutia points to quantify the uniqueness of fingerprints. Although Galton discovered that sweat pores can also be observed on the ridges, no method was proposed to utilize pores for identification.

In 1912, Locard introduced the science of poroscopy, the comparison of sweat pores for the purpose of personal identification. Locard stated that like the ridge characteristics, the pores are also permanent, immutable and unique, and are useful for establishing the identity, especially when a sufficient number of ridges is not available. Locard further studied the variation of sweat pores and proposed four criteria that can be used for pore-based identification: the size of the pores, the form of the pores, the position of the pores on the ridges and the number or frequency of the pores. It was observed that the number of pores along a centimeter of ridge varies from 9 to 18, or 23 to 45 pores per inch and 20 to 40 pores should be sufficient to determine the identity of a person. In particular, pores provide essential information for fragmentary latent print examination since the number of minutia points in latent fragment prints is often too few. One such example is given in FIG. 2, where only one minutia is present in each fragmentary fingerprint, yet the attributes of about 20 pores in these images are sufficient to successfully determine a disagreement (i.e., non-match) between the two prints.

In 1962, Chatterjee proposed the use of ridge edges in combination with other friction ridge formations to establish individualization, which is referred to as “edgeoscopy.” Chatterjee discovered that some shapes on the friction ridge edges tend to reappear frequently and classified them into eight categories, namely, straight, convex, peak, table, pocket, concave, angle and others (e.g., see FIG. 3). Subsequent research established that all the edge characteristics along friction ridges can be placed into one of these categories. It is believed that the differences in edge shapes are caused by the effects of differential growth on the ridge itself or a pore that is located near the edge of the friction ridge. In theory, the density of ridge edge features can be very large, e.g., given the average width of a ridge to be approximately 0.48 mm, a ridge 5 mm long would contain approximately 20 edge characteristics. However, in practice, the flexibility of the friction skin tends to mask all but the largest edge shapes.

Over the last several years, poroscopy and edgeoscopy have received growing attention and have been widely studied by scientists of ridgeology, a fundamental and essential resource for latent print examiners. It has been claimed that shapes and relative positions of sweat pores and shapes of ridge edges are as permanent and unique as traditional minutia points. When understood, they add considerable weight to the conclusion of identification.

Human fingers are known to display friction ridge skin (FRS) that consists of a series of ridges and furrows, generally referred to as fingerprints. The FRS is made of two major layers: dermis (inner layer) and epidermis (outer layer). The ridges emerge on the epidermis to increase the friction between the volar (e.g., hand or foot) and the contact surface (e.g., see FIG. 4a). A typical young male has, on an average, 20.7 ridges per centimeter while a female has 23.4 ridges per centimeter. It is suggested that friction ridges are composed of small “ridge units,” each with a pore, and the number of ridge units and their locations on the ridge are randomly established. As a result, the shape, size, alignment of ridge units and their fusion with an adjacent ridge unit are unique for each person. Although there exists certain cases where ridge units fail to compose a ridge, also known as dysplasia, independent ridge units still exist on the skin.

Pores, on the other hand, penetrate into the dermis starting from the epidermis. They are defined as the openings of subcutaneous sweat glands that are placed on epidermis. Some studies showed that the first sweat gland formations are observed in the fifth month of gestation while the epidermal ridges are not constructed until the sixth month. This implies that the pores are stabilized on the ridges before the process of epidermis and dermis development is completed, and is immutable once the ridge formation is completed. Due to the fact that each ridge unit contains one sweat gland, pores are often considered evenly distributed along ridges and the spatial distance between pores frequently appears to be in proportion to the breadth of the ridge, which, on an average, is approximately 0.48 mm. A pore can be visualized as either open or closed in a fingerprint image based on its perspiration activity. A closed pore is entirely enclosed by a ridge, while an open pore intersects with the valley lying between two ridges (e.g., see FIG. 5). One should not expect to find two separate prints of the same pore to be exactly alike, as a pore may be open in one and closed in the other print.

Occasionally, narrow and often fragmented ridges, also known as incipient ridges, may appear between normal friction ridges. It has been suggested that incipient ridges are normal forming ridges that remained “immature” at the time of differentiation when primary ridge formation stopped. Because pores are formed during the early growth of the ridges, it has been observed that some incipient ridges also have pore formations. It has also been observed that incipient ridges occur in about 45% of people and 13.5% of fingers. The incipient ridges are also permanent and repeatable friction ridge characteristics.

A recent study on the microcirculation of human fingers reveals the complexity and characteristics of fingerprints from a microvascular point of view. It has been found that the regular disposition of capillaries on the palmar side of a finger sharply followed the cutaneous sulci of the fingerprint, reproducing an identical vascular fingerprint with the same individual architecture of the cutaneous area (e.g., see FIG. 4b). The capillaries around the sweat glands also formed a very specialized tubular-shaped structure and the concentration of these structures decreases from the palmar to the dorsal side of the finger.

There are many different sensing methods to obtain the ridge-and-valley pattern of finger skin, or fingerprint. Historically, in law enforcement applications, fingerprints were mainly acquired off-line. Nowadays, most commercial and forensic applications accept live-scan digital images acquired by directly sensing the finger surface with a fingerprint sensor based on optical, solid-state, ultrasonic and other imaging technologies.

The earliest known images of fingerprints were impressions in clay and later in wax. Starting in the late 19th century and throughout the 20th century, the acquisition of fingerprint images was mainly performed by using the so-called “ink-technique,” wherein the subject's finger was coated with black ink and pressed and rolled against a paper card, wherein the card was then scanned producing the digital image. This kind of process is referred to as rolled off-line fingerprint sensing, which is still being used in forensic applications and background checks of applicants for sensitive jobs.

Direct sensing of fingerprints as electronic signals started with optical “live-scan” sensors with the frustrated total internal reflection (“FTIR”) principle. When the finger touches the top side of a glass prism, one side of the prism is illuminated through a diffused light. While the fingerprint valleys that do not touch the glass platen reflect the light, ridges that touch the platen absorb the light. This differential property of light reflection allows the ridges (e.g., which appear dark) to be discriminated from the valleys.

Solid-state fingerprint sensing technique uses silicon-based, direct contact sensors to convert the physical information of a fingerprint into electrical signals. The solid-state sensors are based on capacitance, thermal, electric field, radio frequency (“RF”) and other principles. The capacitive sensor consists of an integrated two-dimensional array of metal electrodes. Each metal electrode acts as one capacitor plate and the contacting finger acts as the second plate. A passivation layer on the surface of the device forms the dielectric between these two plates. A finger pressed against the sensor creates varying capacitance values across the array which is then converted into an image of the fingerprint. Some solid-state sensors can deal with non-ideal skin conditions (e.g., wet or dry fingers) and are suited for use in a wide range of climates. However, the surface of solid-state sensors needs to be cleaned regularly to prevent the grease and dirt from compromising the image quality.

New fingerprint sensing technologies are constantly being explored and developed. For example, multispectral fingerprint imaging (“MSI”) has been introduced by Lumidigm, Inc. Unlike conventional optical fingerprint sensors, MSI devices scan the sub-surface of the skin by using different wavelengths of light (e.g., 470 nm (blue), 574 nm (green), and 636 nm (red)). The fundamental idea is that different features of skin cause different absorbing and scattering actions depending on the wavelength of light. Fingerprint images acquired using the MSI technology appear to be of significantly better quality compared to conventional optical sensors for dry and wet fingers. Multispectral fingerprint images have also been shown to be useful for spoof detection. Another new fingerprint sensing technology based on a multi-camera system, known as “touchless imaging,” has been introduced by TBS, Inc. As suggested by the name, touchless imaging avoids direct contact between the sensor and the skin and thus, consistently preserves the fingerprint “ground truth” without introducing skin deformation during image acquisition. A touchless fingerprint sensing device is also available from Mitsubishi.

One of the most essential characteristics of a digital fingerprint image is its resolution, which indicates the number of dots or pixels per inch (ppi) (e.g. see FIG. 6). Generally, 250 to 300 ppi is the minimum resolution that allows the feature extraction algorithms to locate minutiae in a fingerprint image. FBI-compliant sensors must satisfy the 500 ppi resolution requirement. However, in order to capture pores in a fingerprint image, a significantly higher resolution (e.g., ≧1000 ppi) of image is needed. Although it is not yet practical to design solid-state sensors with such a high resolution due to the cost factor, optical sensors with a resolution of 1000 ppi are already commercially available.

The use of Level 3 features in an automated fingerprint identification system has been studied by only a few researchers. Existing literature is exclusively focused on the extraction of pores in order to establish the viability of using pores in high resolution fingerprint images to assist in fingerprint identification.

For example, Stosz and Alyea proposed a skeletonization-based pore extraction and matching algorithm. Specifically, the locations of all end points (e.g., with at most one neighbor) and branch points (e.g., with exactly three neighbors) in the skeleton image are extracted and each end point is used as a starting location for tracking the skeleton. The tracking algorithm advances one element at a time until one of the following stopping criteria is encountered: (i) another end point is detected, (ii) a branch point is detected, and (iii) the path length exceeds a maximum allowed value. Condition (i) implies that the tracked segment is a closed pore, while condition (ii) implies an open pore. Finally, skeleton artifacts resulting from scars and wrinkles are corrected and pores from reconnected skeletons are removed. The result of pore extraction is shown in FIG. 8. During matching, a fingerprint image is firstly segmented into small regions and those that contain characteristic features, such as core and delta points, are selected. The match score between a given image pair is then defined as a ratio of the number of matched pores to the total number of pores extracted from template regions, in accordance with the algorithm set forth in Equation (1) below:

$${S}_{P} = ( {\sum }_{i = 0}^{{N}_{S} - 1} {N}_{MP , i} ) / ( {\sum }_{i = 0}^{{N}_{S} - 1} {N}_{P , i} ) \qquad ( 1 )$$

where N_{δ} is the total number of regions in the template, N_{P,i} is the number of pores detected in template region i and N_{MP,i} is the number of matching pores in region i. It should be noted that alignment is first established based on maximum intensity correlation and two pores are considered matched if they lie within a certain bounding box. Finally, experimental results based on a database of 258 fingerprints from 137 individuals showed that by combining minutia and pore information, a lower FRR (i.e., false rejection rate) of 6.96% (e.g., compared to ˜31% for minutiae alone) can be achieved at a FAR (i.e., false acceptance rate) of 0.04%.

Based on the above algorithm, Roddy and Stosz later conducted a statistical analysis of pores and presented a model to predict the performance of a pore-based automated fingerprint system. One of the most important contributions of this study is that it mathematically demonstrated the uniqueness of pores, for example, (i) the probability of two consecutive intra-ridge pores having the same relative spatial position with another two pores is 0.04, (ii) the probability of occurrence of a particular combination of 20 consecutive intra-ridge pores is 1.16×10⁻¹⁴, and (iii) the probability of occurrence of a particular combination of 20 ridge-independent pores is 5.186×10⁻⁸. In general, this study provides statistics about pores and demonstrates the efficacy of using pores, in addition to minutiae, for improving the fingerprint recognition performance.

More recently, Kryszczuk et al. studied matching fragmentary fingerprints using minutiae and pores. The authors presented two hypotheses pertaining to Level 3 features: (i) the benefit of using Level 3 features increases as the fingerprint fragment size, or the number of minutiae decreases, and (ii) given a sufficiently high resolution, the discriminative information contained in a small fragment is no less than that in the entire fingerprint image. Further, Kryszczuk et al. pointed out that there exists an intrinsic link between the information content of ridge structure, minutiae and pores. As a result, the anatomical constraint that the distribution of pores should follow the ridge structure is imposed in their pore extraction algorithm, which is also based on skeletonization. Specifically, an open pore is only identified in a skeleton image when distance from an end point to a branch point on the valley is small enough (e.g., see FIG. 9). Finally, an algorithm based on the geometric distance was employed for pore matching.

Although the hypotheses in previous studies by Stosz et al. and Kryszczuk et al. were well supported by the results of their pilot experiments, there are some major limitations in their approaches. For example, skeletonization is effective for pore extraction only when the image quality is very good. As the image resolution decreases or the skin condition is not favorable, this method does not give reliable results (e.g., see FIG. 10). Additionally, comparison of small fingerprint regions based on the distribution of pores requires the selection of characteristic fingerprint segments; which was typically performed manually. Furthermore, the alignment of the test and the query region is established based on intensity correlation, which is computationally expensive by searching through all possible rotations and displacements. The presence of non-linear distortion and noise, even in small regions, can also significantly reduce the correlation value. Also, only custom built optical sensors (e.g., ˜2000 ppi), rather than commercially available live-scan sensors (e.g., 1000 ppi) were used in these studies. Moreover, the database is generally small.

Therefore, there exists a need for new and improved fingerprint recognition and matching systems that are selectively operable to automatically employ and analyze Level 3 features, including but not limited to pore and ridge characteristics, in addition to Level 1 and Level 2 features.

### SUMMARY OF THE INVENTION

In accordance with the general teachings of the present invention, new and improved fingerprint recognition and matching systems are provided.

In accordance with one aspect of the present invention, these systems are operable to employ and analyze Level 3 features, including but not limited to pore and ridge characteristics, as well as Level 1 and Level 2 features.

In accordance with another aspect of the present invention, the system utilizes features at all three fingerprint friction ridge detail levels, i.e., Level 1, Level 2 and Level 3, which are extracted from 1000 ppi fingerprint scans. Level 3 features, including but not limited to pore and ridge contour characteristics, are automatically extracted using various filters (e.g., Gabor filters, edge detector filters, and/or the like) and transforms (e.g., wavelet transforms) and are locally matched using various algorithms (e.g., iterative closest point (ICP) algorithms). Because Level 3 features carry significant discriminatory information, there is a relative reduction of 20% in the equal error rate (EER) of the matching system when Level 3 features are employed in combination with Level 1 and Level 2 features, which are also automatically extracted. This significant performance gain is consistently observed across various quality fingerprint images.

By way of a non-limiting example, the present invention provides a fingerprint matching system that is based on 1000 ppi fingerprint images, e.g., those acquired using CrossMatch 1000ID, a commercial optical live-scan device. In addition to pores and minutiae, ridge contours that contain discriminatory information are also extracted in the algorithms of the present invention. A complete and fully automatic matching framework is provided by efficiently utilizing features at all three levels in a hierarchical fashion. The matching system of the present invention works in a more realistic scenario and demonstrates that inclusion of Level 3 features leads to more accurate fingerprint matching.

In accordance with a first embodiment of the present invention, a method for extracting information from a fingerprint image, wherein the fingerprint image contains Level 1, Level 2 and Level 3 features, is provided, comprising: (1) applying a first filter to the fingerprint image to extract the location of any ridges, wherein a first enhanced fingerprint image is produced by the application of the first filter; and (2) applying a second filter to the fingerprint image to extract the location of any pores, wherein a response is produced by the application of the second filter.

In accordance with a first alternative embodiment of the present invention, a method for determining a match between a first fingerprint image and a second fingerprint image, wherein the first and second fingerprint images contain Level 1, Level 2 and Level 3 features, is provided, comprising: (1) comparing the Level 1 features of the first and second fingerprint images; (2) if no match exists between the Level 1 features of the first and second fingerprint images, then comparing the Level 2 features of the first and second fingerprint images; and (3) if no match exists between the Level 2 features of the first and second fingerprint images, then comparing the Level 3 features of the first and second fingerprint images, wherein the step of comparing the Level 3 features of the first and second fingerprint images comprises: (a) applying a first filter to both of the first and second fingerprint images to extract the location of any ridges, wherein third and fourth enhanced fingerprint images are produced by the application of the first filter to the first and second fingerprint images respectively; and (b) applying a second filter to both of the first and second fingerprint images to extract the location of any pores, wherein first and second responses are produced by the application of the second filter to the first and second fingerprint images respectively.

In accordance with a second alternative embodiment of the present invention, a method for determining a match between a first fingerprint image and a second fingerprint image, wherein the first and second fingerprint images contain Level 1, Level 2 and Level 3 features, is provided, comprising: (1) comparing the Level 1 features of the first and second fingerprint images; (2) if no match exists between the Level 1 features of the first and second fingerprint images, then comparing the Level 2 features of the first and second fingerprint images; and (3) if no match exists between the Level 2 features of the first and second fingerprint images, then comparing the Level 3 features of the first and second fingerprint images, wherein the step of comparing the Level 3 features of the first and second fingerprint images comprises: (a) applying a Gabor filter to both of the first and second fingerprint images to extract the location of any ridges, wherein third and fourth enhanced fingerprint images are produced by the application of the first filter to the first and second fingerprint images respectively; and (b) applying a band pass filter to both of the first and second fingerprint images to extract the location of any pores, wherein first and second responses are produced by the application of the second filter to the first and second fingerprint images respectively, wherein the Level 3 features of the first and second fingerprint images are compared with an iterative closest point algorithm.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 illustrates fingerprint features at Level 1 (upper row), Level 2 (middle row) and Level 3 (lower row), in accordance with the prior art;

FIGS. 2a and 2b illustrate the role of pores in fragmentary latent print examination, wherein FIGS. 2a and 2b are fingerprint segments from different fingers, wherein each figure shows a bifurcation at the same location on similar patterns such that normal examination would find them in agreement, but their relative pore locations differ, in accordance with the prior art;

FIG. 3 illustrates characteristic features of friction ridges, in accordance with the prior art;

FIG. 4a illustrates friction ridge skin including a three-dimensional representation of the structure of ridged skin, wherein the epidermis is partly lifted from the dermis to expose the dermal papillae, in accordance with the prior art;

FIG. 4b illustrates friction ridge skin including a finger seen during the maceration process shows (A) the regular linear disposition of vessels along the fingerprints and (B) two rows of vessels are seen at low magnification revealing perfect correspondence, in accordance with the prior art;

FIG. 5 illustrates open and closed pores in a 1000 ppi live-scan fingerprint image obtained using a CrossMatch 1000ID scanner, in accordance with the prior art;

FIGS. 6a-6c illustrate fingerprint image resolution, wherein the same fingerprint is captured at three different image resolutions including 380 ppi with an Identix 200DFR (see FIG. 6a), 500 ppi with a CrossMatch 1000ID (see FIG. 6b), and 1000 ppi with a CrossMatch 1000ID (see FIG. 6c), in accordance with the prior art;

FIGS. 7a and 7b illustrate pore detection based on skeletonization, wherein FIG. 7a shows a fingerprint image (2000 ppi) with detected pores (in the square box) and FIG. 7b shows the raw skeleton image where end points and branch points are tracked for pore extraction, in accordance with the prior art;

FIGS. 8a and 8b illustrate pore detection in fingerprint fragments, wherein FIG. 8a shows detection of open pores and FIG. 8b shows extraction of open pores (in white) and closed pores (in black), in accordance with the prior art;

FIGS. 9a-9c illustrate the sensitivity of skeletonization to various skin conditions and noise, wherein effects of degradation on gray scale (see FIG. 9a), binary (see FIG. 9b), and raw skeleton images (see FIG. 9c) are observed for three different sources of noise (e.g., wet finger, dry finger, and wrinkle), in accordance with the prior art;

FIG. 10 illustrates impressions of the same finger at 1000 ppi, wherein it is observed that ridge contours are more reliable Level 3 features compared to pores, in accordance with the general teachings of the present invention;

FIGS. 11a-11f illustrate pore extraction, including a partial fingerprint image at 1000 ppi (see FIG. 11a), enhancement of ridges in the image shown in FIG. 11a using Gabor filters (see FIG. 11b), a linear combination of FIGS. 11a and 11b (see FIG. 11c), a wavelet response (s=1.32, e.g., see equation (3)) of the image in FIG. 11a (see FIG. 11d), a linear combination of FIGS. 11b and 11d (see FIG. 11e), and extracted pores (black circles) after thresholding the image in FIG. 11e (see FIG. 11f), in accordance with the general teachings of the present invention;

FIGS. 12a-12c illustrate ridge contour extraction, including wavelet response (s=1.74, e.g., see equation (3)) of the image in FIG. 11a (see FIG. 12a), ridge contour enhancement using a linear subtraction of wavelet response in FIG. 12a and Gabor enhanced image in FIG. 11a (see FIG. 12b), and extracted ridge contours after binarizing FIG. 12b and convolving with filter H (see FIG. 12c), in accordance with the general teachings of the present invention;

FIG. 13 illustrates a system flow chart, wherein fingerprint features at three different levels are utilized in a hierarchical fashion, in accordance with the general teachings of the present invention;

FIGS. 14a-14c illustrates different levels of fingerprint features detected in FIG. 6c, wherein these features are utilized in the matching system of the present invention including orientation field (Level 1) (see FIG. 14a), minutiae points (Level 2) (see FIG. 14b), and pores and ridge contours (Level 3) (see FIG. 14c), in accordance with the general teachings of the present invention;

FIG. 15 illustrates the effect of using Level 3 features, wherein the overlap region of the genuine and imposter distributions of matched minutiae is reduced after Level 3 features are utilized, wherein curves corresponding to MP are based on Level 2 features alone and curves corresponding to MP′ are based on Level 2 and Level 3 features, in accordance with the general teachings of the present invention;

FIGS. 16a and 16b illustrate an example of using an ICP algorithm for Level 3 matching, wherein after k=6 iterations, the match distance between P^{T} and P^{Q} was reduced from 3.03 in FIG. 16a to 1.18 in FIG. 16b, in accordance with the general teachings of the present invention;

FIG. 17 illustrates ROC (i.e., receiver operating characteristic) curves for the Level 2 matcher (minutiae-based) and the matcher of the present invention that utilizes Level 2 and Level 3 features, in accordance with the general teachings of the present invention; and

FIG. 18 illustrates ROC curves for high quality (HQ) and low quality (LQ) images for the Level 2 matcher (minutiae-based) and the matcher of the present invention, in accordance with the general teachings of the present invention.

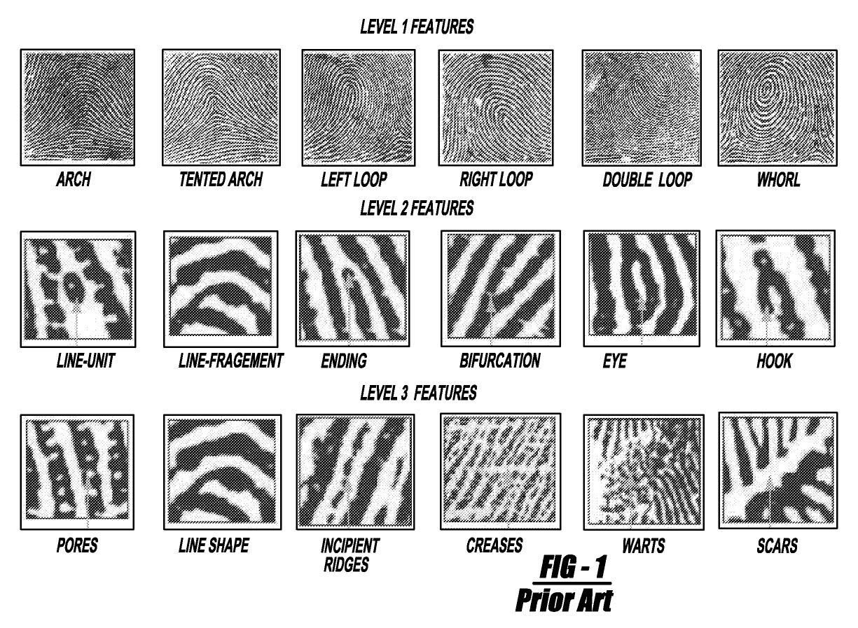

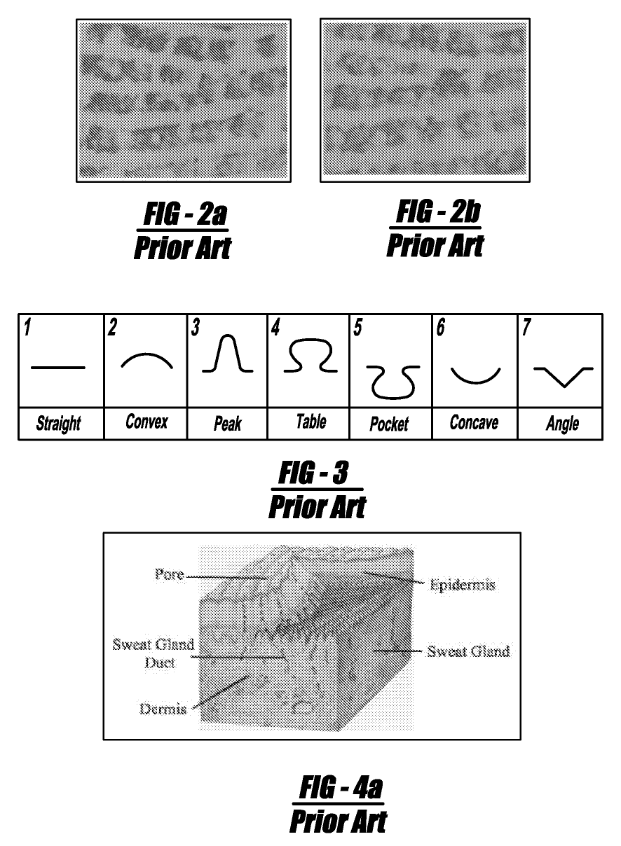

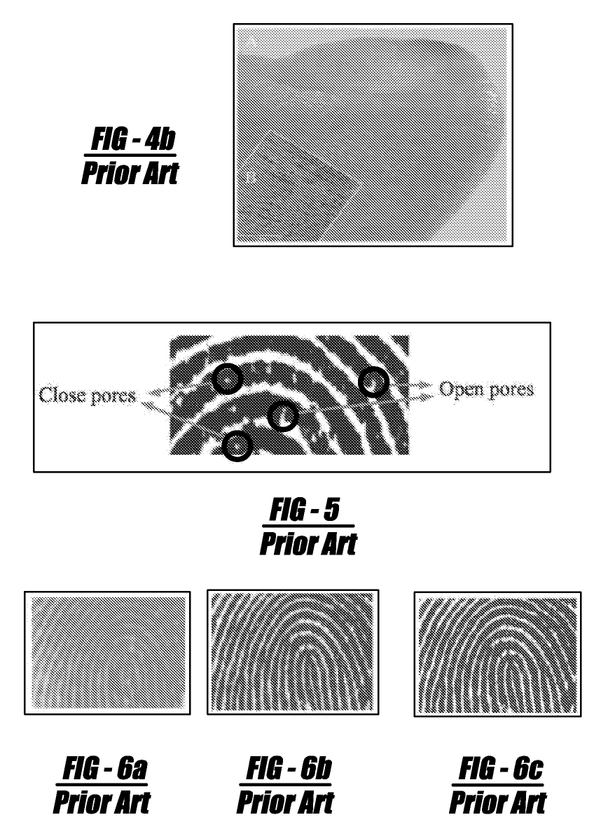

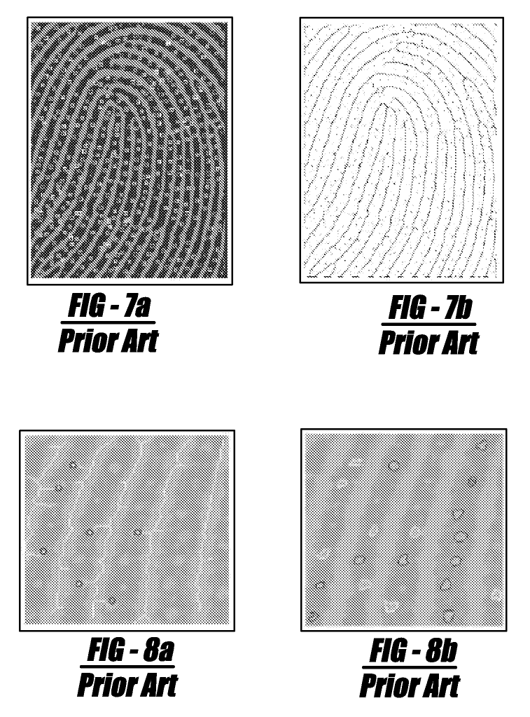

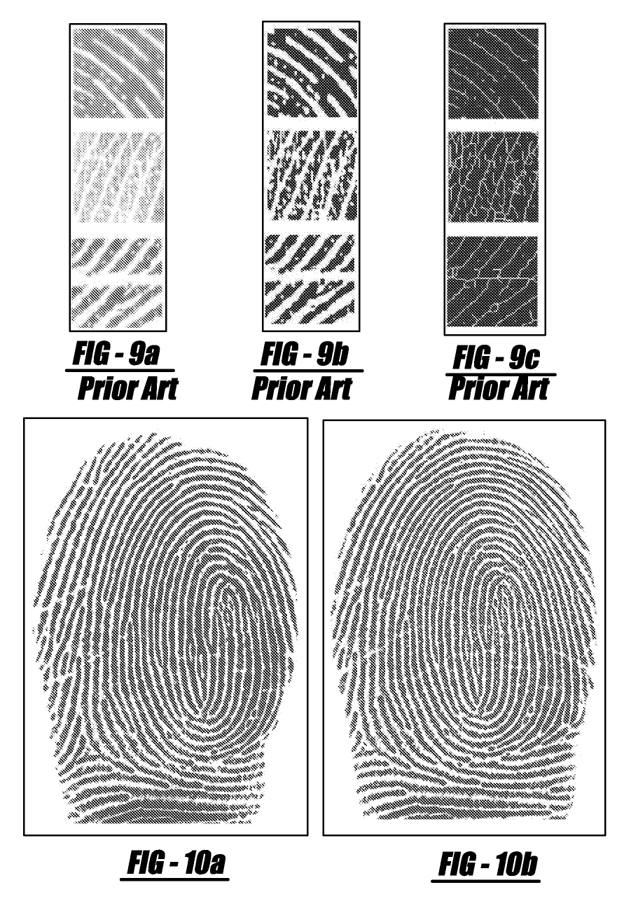

### DETAILED DESCRIPTION OF THE INVENTION

The following description of the preferred embodiment(s) is merely exemplary in nature and is in no way intended to limit the invention, its application, or uses.

In accordance with one aspect of the present invention, Level 1, Level 2 and Level 3 features in a fingerprint image were mutually correlated. For example, the distribution of pores was not random, but naturally followed the structure of ridges. Also, based on the physiology of the fingerprint, pores were only present on the ridges, not in the valleys. Therefore, it was essential that the locations of ridges were identified prior to the extraction of pores. Besides pores, ridge contours were also considered as Level 3 information. During image acquisition, it was observed that the ridge contour was often more reliably preserved at 1000 ppi than the pores, especially in the presence of various skin conditions and sensor noise (e.g., see FIG. 10). In order to automatically extract Level 3 features, namely, pores and ridge contours, the present invention provides feature extraction algorithms using, among other things, Gabor filters and wavelet transforms. It should also be appreciated that the present invention can be practiced with images that include less than or more than 1000 ppi. Any references to 1000 ppi images are for illustrative purposes only.

Based on their positions on the ridges, pores can be divided into two categories: open and closed. A closed pore is entirely enclosed by a ridge, while an open pore intersects with the valley lying between the two ridges. However, it was not useful to distinguish between the two states for matching because a pore may be open in one image and closed in the other image, depending on the perspiration activity. One common property of pores in a fingerprint image is that they are all naturally distributed along the friction ridge. As long as the ridges are identified, the locations of pores were also determined, regardless of their being open or closed.

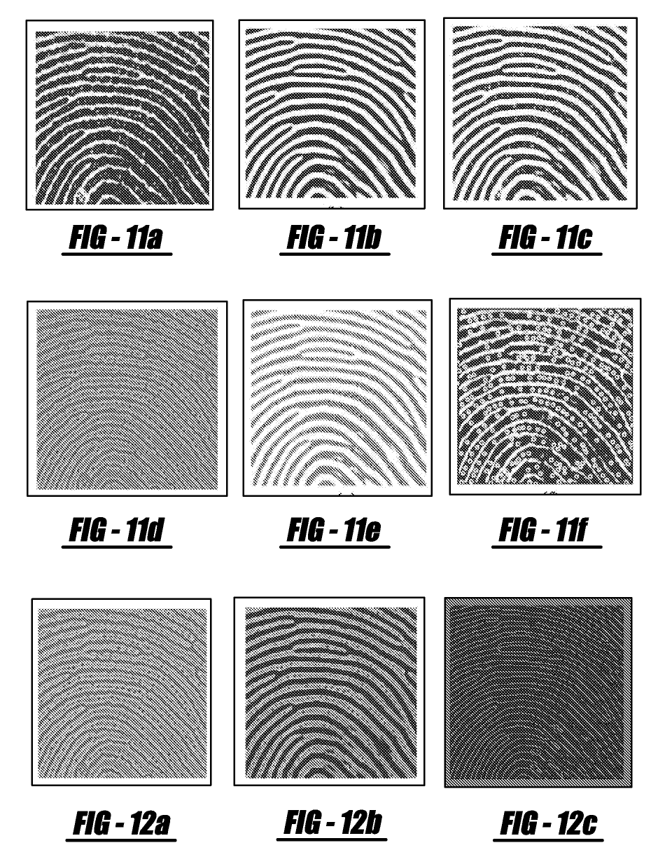

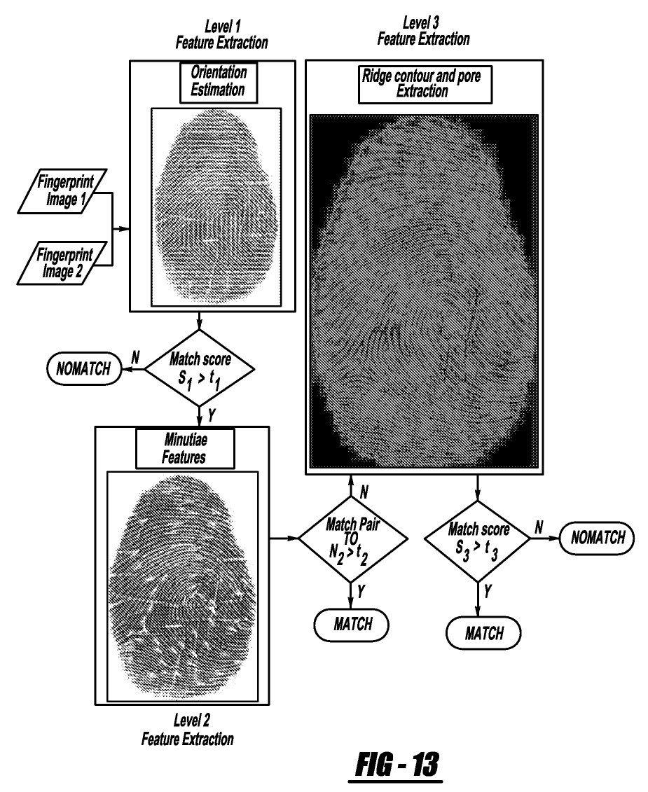

To enhance the ridges, Gabor filters were used, which have the form set forth in the algorithm in Equation 2 below:

$$G ( x , y : θ , f ) = exp \{ - \frac{1}{2} [ \frac{{x}_{θ}^{2}}{{δ}_{x}^{2}} + \frac{{y}_{θ}^{2}}{{δ}_{y}^{2}} ] cos ( 2 π {fx}_{θ} ) \} \qquad ( 2 )$$

where θ and f are the orientation and frequency of the filter, respectively, and δₓ and δ_{y} are the standard deviations of the Gaussian envelope along the x- and y-axes, respectively. Here, (x_{θ},y_{θ}) represents the position of a point (e.g., x, y) after it has undergone a clockwise rotation by an angle (e.g., 90°−θ). The four parameters (i.e., θ, f, δₓ,δ_{y}) of the Gabor filter were empirically determined based on the ridge frequency and orientation of the fingerprint image. A non-limiting example of a fingerprint image (e.g., see FIG. 11a) that has been enhanced after Gabor filtering is shown in FIG. 11b. It is clear that the ridges were well separated from the valleys after enhancement.

The above procedure suppressed noise by filling all the holes (or pores) on the ridges and highlighted only the ridges. By simply adding it to the original fingerprint image, it was observed that both open and closed pores are retained as they appear only on the ridges (e.g., see FIG. 11c). However, the contrast between pores and ridges was low in FIG. 11c. In order to enhance the original image with respect to pores, a band pass filter was employed to capture the high negative frequency response as intensity values change abruptly from white to black at the pores. Wavelet transform is known for its highly localized property in both frequency and spatial domains. Hence, the Mexican hat wavelet transform was applied to the input image f(x, y)εR² to obtain the frequency response w, as set forth in the algorithm in Equation 3 below:

$$w ( s , a , b ) = \frac{1}{\sqrt{s}} \int {\int }_{{R}^{2}} f ( x , y ) φ ( \frac{x - a}{s} , \frac{y - b}{s} ) d x d y , \qquad ( 3 )$$

where s is the scale factor (=1.32) and (a, b) are the shifting parameters. Essentially, this wavelet was a band pass filter with scales. After normalizing the filter response (e.g., 0-255) using min-max normalization, pore regions that typically have high negative frequency response were represented by small blobs with low intensities (e.g., see FIG. 11d). By adding the responses of Gabor and wavelet filters, the “optimal” enhancement of pores was obtained while enforcing the constraint that pores lie only on the ridges (e.g., see FIG. 11e). Finally, an empirically determined threshold (e.g., =58) was applied to extract pores with blob size less than 40 pixels. An example of pore extraction is shown in FIG. 11f, where ˜250 pores, both open and closed, were accurately extracted along the ridges.

It should be noted that the proposed pore extraction algorithms are simple and more efficient than the commonly used skeletonization-based algorithms, which are often tedious and sensitive to noise, especially when the image quality is poor.

As noted, while pores were visible in 1000 ppi fingerprint images, their presence was not consistent (e.g., see FIG. 10). On the other hand, ridge contours, which contain valuable Level 3 information including ridge width and edge shape, were observed to be more reliable features than pores. Hence, ridge contours were also extracted for the purpose of matching.

The ridge contour was generally defined as edges of a ridge. However, there was a fundamental difference between the use of ridge contours and what is proposed in “edgeoscopy.” In “edgeoscopy,” the edge of a ridge is classified into seven categories, e.g., as shown in FIG. 3. In practice, however, the flexibility of the friction skin and the presence of open pores tend to reduce the reliability of ridge edge classification. In contrast to edgeoscopy, the present invention utilizes the ridge contour directly as a spatial attribute of the ridge and the matching was based on the spatial distance between points on the ridge contours. Classical edge detection algorithms can be applied to fingerprint images to extract the ridge contours. However, the detected edges are often very noisy due to the sensitivity of the edge detector to the presence of creases and pores. Hence, the present invention used wavelets to enhance the ridge contours and linearly combine them with a Gabor enhanced image (e.g., where broken ridges are fixed) to obtain enhanced ridge contours.

The algorithm to extract ridge contours can be described as follows. First, the image is enhanced using Gabor filters as in Equation (2). Then, a wavelet transform was applied to the fingerprint image to enhance ridge edges (e.g., see FIG. 12a). It needs to be noted that the scale s in Equation (3) was increased to 1.74 in order to accommodate the intensity variation of ridge contours. The wavelet response was subtracted from the Gabor enhanced image such that ridge contours were further enhanced (e.g., see FIG. 12b). The resulting image was binarized using an empirically defined threshold δ(=10). Finally, ridge contours can be extracted by convolving the binarized image f^{b}(x, y) with a filter H, given by the algorithm in Equation 4, below:

r(x,y)=Σ_{n,m}f^{b}(x,y)H(x−n, y−m), (4)

where filter H=(0, 1, 0; 1, 0, 1; 0, 1, 0) counts the number of neighborhood edge points for each pixel. A point (e.g., x, y) is classified as a ridge contour point if r(x, y)=1 or 2. FIG. 12c shows the extracted ridge contours.

In latent print comparison, a forensic expert often investigates Level 3 details when Level 1 or Level 2 features are similar between the template and the query. That is, experts take advantage of an extended feature set in order to conduct a more effective latent matching. A possible improvement of current AFIS systems is then to employ a similar hierarchical matching scheme, which enables the use of an extended feature set for matching at a higher level to achieve robust matching decisions.

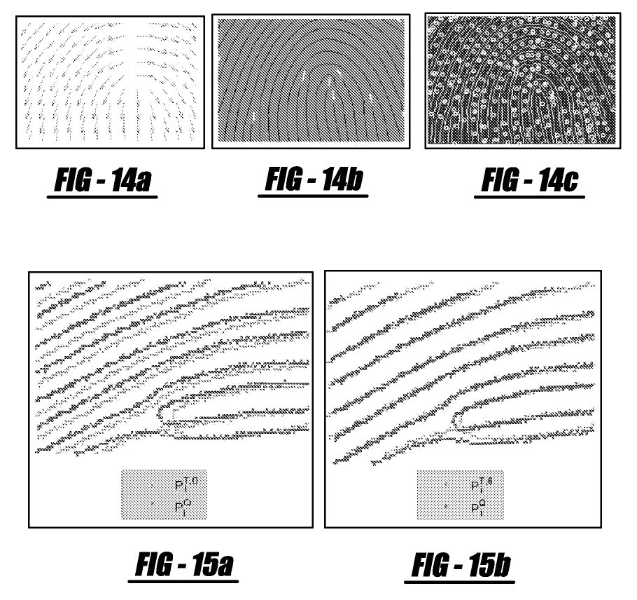

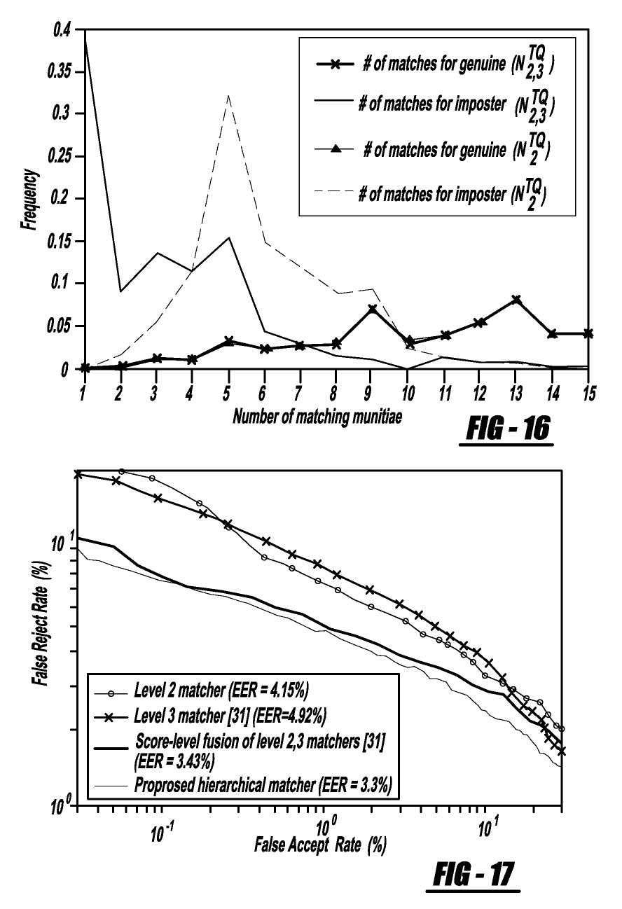

FIG. 13 illustrates the architectural design of the proposed matching system of the present invention. Each layer in the system utilized features at the corresponding level. All the features that were used in the system are shown in FIG. 14.

Given two fingerprint images, the system first extracted Level 1 (e.g., orientation field) and Level 2 (e.g., minutiae) features and established alignment of the two images using a string-matching algorithm. Agreement between orientation fields of the two images was then calculated using dot-product. If the orientation fields disagreed (e.g., S₁<t₁), the matcher rejected the query and stopped at Level 1. Otherwise, the matcher proceeded to Level 2, where minutia correspondences were established using bounding boxes and the match score S₂ was computed in accordance with the algorithm in Equation (5), below:

$${S}_{2} = {w}_{1} \times {S}_{1} + {w}_{2} \times \frac{1}{2} ( \frac{{N}_{2}^{TQ} - 0.20 \times ( {N}_{2}^{T} - {N}_{2}^{TQ} )}{{N}_{2}^{T} + 1} 1 + \frac{{N}_{2}^{TQ} - 0.20 \times ( {N}_{2}^{Q} - {N}_{2}^{TQ} )}{{N}_{2}^{Q} + 1} ) \qquad ( 5 )$$

where w₁ and w₂(=1−w₁) are the weights for combining information at Level 1 and Level 2, N₂^{TQ} is the number of matched minutiae and N₂^{T} and N₂^{Q} are the number of minutiae within the overlapping region of the template (T) and the query (Q), respectively. Note that it is required that 0≦S₂≦100.

Next, the threshold t₂ was set to be 12, such that if N₂^{TQ}>12, positive identification in many courts of law, the matching terminated at Level 2 and the final match score remained as S₂. Otherwise, investigation of Level 3 features continued. The threshold t₂ was chosen based on the 12-point guideline that was considered as sufficient evidence for making positive identification in many courts of law.

As the matching proceeded to Level 3, the matched minutiae at Level 2 were further examined in the context of neighboring Level 3 features. For example, given a pair of matched minutiae, Level 3 features were compared in the neighborhood and recomputed the correspondence based on the agreement of Level 3 features. Assuming an alignment had been established at Level 2, (xᵢ, yᵢ), i=1, 2, . . . , N₂^{TQ} was the location of the i-th matched minutia and ( x̅, y̅) was the mean location of all matched minutiae. The associated region of each matched minutia (xᵢ, yᵢ) was defined as a rectangular window Rᵢ with size 60×120, centered at

$$\frac{{x}_{i} + \overline{x}}{2} , \frac{{y}_{i} + \overline{y}}{2} .$$

It should be noted that it is possible the minutiae was outside of its associated region, but the selection ensured a sufficiently large foreground region for Level 3 feature extraction. To compare Level 3 features in each local region, the fact that the numbers of detected features (e.g., pores and ridge contour points) needed to be taken into consideration, in practice, would be different between query and template, due to degradation of image quality (e.g., skin deformation). The Iterative Closest Point (ICP) algorithm was a good solution for this problem because it aimed to minimize the distances between points in one image to geometric entities (as opposed to points) in the other without requiring 1:1 correspondence. Another advantage of ICP was that when applied locally, it provided alignment correction to compensate for nonlinear deformation, assuming that the initial estimate of the transformation was reasonable.

For each matched minutia set (xᵢ, yᵢ), i=1, 2, . . . , N₂^{TQ}, its associated regions from T and Q were defined to be Rᵢ^{T} and Rᵢ^{Q}, respectively and the extracted Level 3 feature sets Pᵢ^{T}=(a_{i,j}, b_{i,j},t_{i,j}), j=1, 2, . . . N_{3,i}^{T} and Pᵢ^{Q}=(a_{i,k},b_{i,k},t_{i,k}), k=1, 2, . . . N_{3,i}^{Q}, accordingly. Each feature set included triplets representing the location of each feature point and its type (e.g., pore or ridge contour point). It should be noted that matching pores with ridge contour points was avoided. The details of matching each Level 3 feature set Pᵢ^{T} and Pᵢ^{Q} using the ICP algorithm (e.g., see FIG. 15) are given in the Table, below:

TABLE

| 1. | | Initialize iteration index k − 0; |
|---|---|---|
| 2. | | Initialize Pᵢ^{T,O} = Pᵢ^{T} and rigid transformation Wᵢ^{O} = I; |
| 3. | | Initialize convergence indicator Diff = 10¹⁰; |
| 4. | | Set the stop criterion for distance D = 0.03; |
| 5. | | Set the stop criterion for iteration Itr = 15; |
| 6. | | While (Diff > D) |
| { | | |
| | 6.1 | If (k ≧ Itr) break; |
| | 6.2 | k = k + 1 |
| | 6.3 | Apply Wᵢ^{k-1} to the query Pᵢ^{T,k} = Wᵢ^{k-1}Pᵢ^{T,k-1}; |
| | 6.4 | For (j = 1 to N_{3,i}^{Q} |
| | | { |
| | | Find index of the closest point for (a_{i,j}^{Q}, b_{i,j}^{Q}, t_{i,j}^{Q}): |
| | | C^{k} (j) = argmin_{g} (d((a_{i,g}^{T,k}, b_{i,g}^{T,k}, t_{i,g}^{T,k}), (a_{i,j}^{Q}, b_{i,j}^{Q}, t_{i,j}^{Q}))), |
| | | g = 1, 2, . . . , N_{3,i}^{T}} |
| | 6.5 | Compute the mean distance between Pᵢ^{T,k} and Pᵢ^{Q} |
| | ${E}_{i}^{k} ( {P}_{i}^{T , k} , {P}_{i}^{Q} ) = \frac{1}{{N}_{3 , i}^{Q}} {\sum }_{j = 1}^{{N}_{3 , i}^{Q}} d ( ( {a}_{i , {C}^{k} ( j )}^{T , k} , {b}_{i , {C}^{k} ( j )}^{T , k} , {t}_{i , {C}^{k} ( j )}^{T , k} ) , ( {a}_{i , j}^{Q} , {b}_{i , j}^{Q} , {t}_{i , j}^{Q} ) ) ;$ | |
| | 6.6 | Obtain new transformation Wᵢ^{k} that minimize Eᵢ^{k}; |
| | 6.7 | Estimate convergence at iteration k |
| | | Diff = Eᵢ^{k} (Pᵢ^{T,k}, Pᵢ^{Q}) − Eᵢ^{k-1} (Pᵢ^{T,k-1}, Pᵢ^{Q}); |

| | |
|---|---|
| 7. | Obtain the match distance Eᵢ = Eᵢ^{k} (Pᵢ^{T,k}, Pᵢ^{Q}) |

The initial transformation Wᵢ^{O} in Step 2 was set equal to the identity matrix I as Pᵢ^{T} and had been pre-aligned at Level 2. In steps 6.4 and 6.5, d(., .) denoted the Euclidean distance between point sets. It should be noted that ICP required N_{3,i}^{Q}, the number of Level 3 features in query region Rᵢ^{Q}, always be smaller than N_{3,i}^{T}, the number of Level 3 features in Rᵢ^{T}. This could be satisfied by choosing the feature set with the larger size to be the template. Fast convergence of the ICP algorithm was usually assured because the initial alignment based on minutiae at Level 2 was generally good. When the algorithm converged or was terminated when k=15, the match distance Eᵢ was obtained.

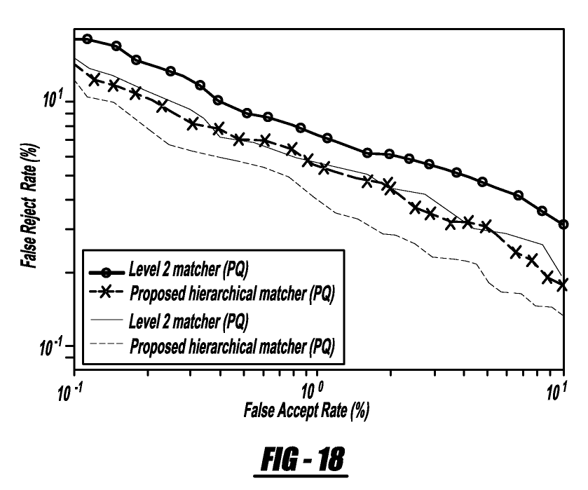

Given N₂^{TQ} matched minutiae between T and Q at Level 2, N₂^{TQ} match distances Eᵢ, i=1, 2, . . . , N₂^{TQ} based on Level 3 features was obtained using the above algorithm. Each distance Eᵢ was then compared with a threshold t_{d} and if Eᵢ<t_{d}, the associated minutia correspondence was ensured, otherwise, the correspondence was denied. N_{2,3}^{TQ} was the updated number of matched minutiae, N_{2,3}^{TQ}≦N₂^{TQ} (e.g., see FIG. 16). The match score S₃ was defined in accordance with the algorithm set forth in Equation (6), below:

$${S}_{3} = {w}_{1} \times {S}_{1} + {w}_{2} \times \frac{1}{2} ( \frac{{N}_{2 , 3}^{TQ} - 0.20 \times ( {N}_{2}^{T} - {N}_{2 , 3}^{TQ} )}{{N}_{2}^{T} + 1} 1 + \frac{{N}_{2 , 3}^{TQ} - 0.20 \times ( {N}_{2}^{Q} - {N}_{2 , 3}^{TQ} )}{{N}_{2}^{Q} + 1} ) , \qquad ( 6 )$$

where N₂^{T} and N₂^{Q}, as before, are the number of minutiae within the overlapped region of the template and the query, respectively. It should be noted that 0≦S3≦100.

The proposed hierarchical matcher utilized a fusion scheme that integrated the feature information at Level 2 and Level 3 in a cascade fashion. An alternative approach that integrates match scores at Level 2 and Level 3 in a parallel fashion was also proposed, where min-max normalization and sum rule were employed to fuse the two match scores. Although the latter is a more commonly used and straightforward approach, it is more time-consuming because matching at both Level 2 and Level 3 has to be performed for every query. In addition, parallel score fusion is sensitive to the selected normalization scheme and fusion rule. On the other hand, the proposed hierarchical matcher enables the present invention to control the level of information, or features to be used at different stages of fingerprint matching.

By way of a non-limiting example, a 1000 ppi fingerprint database was assembled with 410 fingers (e.g., 41 subjects×10 fingers per subject) using a CrossMatch 1000ID sensor. Each finger contributed four impressions (e.g., 2 impressions×2 sessions with an interval of three days) resulting in 1,640 fingerprint images in a database.

Experiments were carried out to estimate the performance gain of utilizing Level 3 features in a hierarchical matching system, and more importantly, across two different fingerprint image quality types. The average time of feature extraction and matching at Level 3 was ˜3.5 seconds per image and ˜45 seconds per match, respectively, when tested on a PC with 1 GB of RAM and a 1.6 GHz Pentium 4 CPU. All programs were implemented in MATLAB.

In the first experiment, the matching performance of the proposed hierarchical matcher was compared to that of the individual Level 2 and Level 3 matchers and their score-level fusion across the entire database. For each matcher, the number of genuine and impostor matches was 2,460 (e.g., 410×6) and 83,845 (e.g., (410×409)/2), respectively. It should be noted that symmetric matches of the same pair were excluded, as well as matches between the same images. As shown in FIG. 17, the proposed hierarchical matcher resulted in a relative performance gain of ˜20% in terms of EER over the Level 2 matcher. It also consistently outperformed the score-level fusion of individual Level 2 and Level 3 matchers, especially at high FAR values. These results strongly suggest that Level 3 features provided valuable complementary information to Level 2 features and can significantly improve the current AFIS matching performance when combined with Level 2 features using the proposed hierarchical structure.

In the second experiment, the aim was to test whether the performance gain of the proposed hierarchical matcher was consistently observed across different image quality. The entire database was divided into two equal-sized groups with respect to image quality, namely, high quality (HQ) and low quality (LQ) and applied both Level 2 matcher and the proposed hierarchical matcher to each group exclusively. The average number of genuine and impostor matches for each quality group, respectively, was 820 and 20,961. The fingerprint image quality measure employed was based on spatial coherence. It should be noted that this quality measure also favored large-sized fingerprints; hence, images with small fingerprint regions were often assigned low quality values. As shown in FIG. 18, consistent performance gain of the proposed hierarchical matcher over the Level 2 matcher was observed across different image quality groups. This result contradicted the general assertion that Level 3 features should only be used when the fingerprint image is of high quality. In fact, high quality fingerprint images typically contain a sufficiently large number of Level 2 features for accurate identification. It is often the fingerprint images with low quality, especially prints of small size (e.g., mostly seen in latent prints), that gain the most from matching using Level 3 features.

In general, the above experiments showed significant performance improvement when combining Level 2 and Level 3 features in a hierarchical fashion. It was demonstrated that Level 3 features did provide additional discriminative information and should be used in combination with Level 2 features. The results strongly suggested that using Level 3 features in fingerprint matching at 1000 ppi was both practical and beneficial.

In summary, the present invention provides an automated fingerprint matching system that utilizes fingerprint features in 1000 ppi images at all three levels. To obtain discriminatory information at Level 3, algorithms based on Gabor filters and wavelet transforms were provided to automatically extract pores and ridge contours. A modified ICP algorithm was employed for matching Level 3 features. The experimental results demonstrated that Level 3 features should be examined to refine the establishment of minutia correspondences provided at Level 2. More importantly, consistent performance gains were also observed in both high quality and low quality images, suggesting that automatically extracted Level 3 features can be informative and robust, especially when the fingerprint region, or the number of Level 2 features, is small.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method for extracting information from a fingerprint image, wherein the fingerprint image contains Level 1, Level 2 and Level 3 features, comprising:
applying a first filter to the fingerprint image to extract the location of any ridges;
wherein a first enhanced fingerprint image is produced by the application of the first filter; and
applying a second filter to the fingerprint image to extract the location of any pores;
wherein a response is produced by the application of the second filter.

2. The invention according to claim 1, wherein the response is combined with the first enhanced fingerprint image to produce a second enhanced fingerprint image, wherein the location of the ridges and pores are enhanced.

3. The invention according to claim 1, wherein the first filter is a Gabor filter.

4. The invention according to claim 1, wherein the second filter is a band pass filter.

5. The invention according to claim 4, wherein the band pass filter is a wavelet transform.

6. The invention according to claim 5, wherein the wavelet transform is a Mexican Hat wavelet transform.

7. The invention according to claim 1, wherein the response is subtracted from the first enhanced image to produce a third enhanced fingerprint image, wherein any contours of the ridges are enhanced.

8. The invention according to claim 7, wherein the third enhanced fingerprint image is binarized to produce a fourth enhanced fingerprint image.

9. The invention according to claim 8, wherein the fourth enhanced fingerprint image is convolved to produce a fifth enhanced fingerprint image.

10. The invention according to claim 1, wherein the fingerprint image is a 1000 pixel per square inch image.

11. A method for determining a match between a first fingerprint image and a second fingerprint image, wherein the first and second fingerprint images contain Level 1, Level 2 and Level 3 features, comprising:
comparing the Level 1 features of the first and second fingerprint images;
if no match exists between the Level 1 features of the first and second fingerprint images, then comparing the Level 2 features of the first and second fingerprint images; and
if no match exists between the Level 2 features of the first and second fingerprint images, then comparing the Level 3 features of the first and second fingerprint images;
wherein the step of comparing the Level 3 features of the first and second fingerprint images comprises:
applying a first filter to both of the first and second fingerprint images to extract the location of any ridges;
wherein third and fourth enhanced fingerprint images are produced by the application of the first filter to the first and second fingerprint images respectively; and
applying a second filter to both of the first and second fingerprint images to extract the location of any pores;
wherein first and second responses are produced by the application of the second filter to the first and second fingerprint images respectively.

12. The invention according to claim 11, wherein the first response is combined with the first enhanced fingerprint image to produce a third enhanced fingerprint image, wherein the location of the ridges and pores are enhanced or wherein the second response is combined with the second enhanced fingerprint image to produce a fourth enhanced fingerprint image.

13. The invention according to claim 11, wherein the first filter is a Gabor filter.

14. The invention according to claim 11, wherein the second filter is a band pass filter.

15. The invention according to claim 14, wherein the band pass filter is a wavelet transform.

16. The invention according to claim 15, wherein the wavelet transform is a Mexican Hat wavelet transform.

17. The invention according to claim 11, wherein the first response is subtracted from the first enhanced image to produce a fifth enhanced fingerprint image, wherein any contours of the ridges are enhanced or wherein the second response is subtracted from the second enhanced image to produce a sixth enhanced fingerprint image, wherein any contours of the ridges are enhanced.

18. The invention according to claim 17, wherein either of the fifth or sixth enhanced fingerprint images are binarized to produce a seventh enhanced fingerprint image.

19. The invention according to claim 18, wherein the seventh enhanced fingerprint image is convolved to produce an eighth enhanced fingerprint image.

20. The invention according to claim 11, wherein either of the first or second fingerprint images is a 1000 pixel per square inch image.

21. The invention according to claim 11, wherein the Level 3 features of the first and second fingerprint images are compared with an iterative closest point algorithm.

22. The invention according to claim 22, wherein the iterative closest point algorithm was applied to a local region of either the first or second fingerprint images.

23. A method for determining a match between a first fingerprint image and a second fingerprint image, wherein the first and second fingerprint images contain Level 1, Level 2 and Level 3 features, comprising:
comparing the Level 1 features of the first and second fingerprint images;
if no match exists between the Level 1 features of the first and second fingerprint images, then comparing the Level 2 features of the first and second fingerprint images; and
if no match exists between the Level 2 features of the first and second fingerprint images, then comparing the Level 3 features of the first and second fingerprint images;
wherein the step of comparing the Level 3 features of the first and second fingerprint images comprises:
applying a Gabor filter to both of the first and second fingerprint images to extract the location of any ridges;
wherein third and fourth enhanced fingerprint images are produced by the application of the first filter to the first and second fingerprint images respectively; and
applying a band pass filter to both of the first and second fingerprint images to extract the location of any pores;
wherein first and second responses are produced by the application of the second filter to the first and second fingerprint images respectively.
wherein the Level 3 features of the first and second fingerprint images are compared with an iterative closest point algorithm.

24. The invention according to claim 23, wherein the first response is combined with the first enhanced fingerprint image to produce a third enhanced fingerprint image, wherein the location of the ridges and pores are enhanced or wherein the second response is combined with the second enhanced fingerprint image to produce a fourth enhanced fingerprint image.

25. The invention according to claim 23, wherein the band pass filter is a wavelet transform.

26. The invention according to claim 25, wherein the wavelet transform is a Mexican Hat wavelet transform.

27. The invention according to claim 23, wherein the first response is subtracted from the first enhanced image to produce a fifth enhanced fingerprint image, wherein any contours of the ridges are enhanced or wherein the second response is subtracted from the second enhanced image to produce a sixth enhanced fingerprint image, wherein any contours of the ridges are enhanced.

28. The invention according to claim 27, wherein either of the fifth or sixth enhanced fingerprint images is binarized to produce a seventh enhanced fingerprint image.

29. The invention according to claim 28, wherein the seventh enhanced fingerprint image is convolved to produce an eighth enhanced fingerprint image.

30. The invention according to claim 23, wherein either of the first or second fingerprint images is a 1000 pixel per square inch image.

31. The invention according to claim 23, wherein the iterative closest point algorithm was applied to a local region of either the first or second fingerprint images.
